(19) United States
(12) Patent Application Publication
(10) Pub. No.: US 2014/0062784 A1
(43) Pub. Date: Mar. 6, 2014

(54) LOCATION-ASSISTED BEAMFORMING

(71) Applicant: Mark Gorthorn RISON, Cambridge (GB)

(72) Inventor: Mark Gorthorn RISON, Cambridge (GB)

(73) Assignee: Cambridge Silicon Radio Limited, Cambridge (GB)

(21) Appl. No.: 13/597,864

(22) Filed: Aug. 29, 2012

(51) Int. Cl. H01Q 3/00

(52) U.S. Cl. 342/368

(57) ABSTRACT

The present invention relates to improving the throughput and power efficiency of communication systems that use beamforming to accurately orient transmission of signals between emitters and receivers. A first communication device implements adaptive beamforming with respect to a second communication device. That is, the first communication device controls the degree and/or direction of the anisotropy of a receiver and/or transmitter that it comprises according to the direction in which the second communication device is determined to lie, said determination being made using a communication between the first and second devices at a particular time. A suitable time for that adaptive beamforming communication to be made is chosen according to position data obtained from one or both of the communication devices.

The present invention relates to adaptive beamforming. More specifically, an aspect of the invention relates to improving the throughput and power efficiency of communication systems that use beamforming to accurately orient transmission of signals between emitters and receivers.

Further, the invention relates to a method of location-assisted adaptive beamforming and apparatus for carrying out said method.

A well understood problem in the field of wireless communications is the inefficiency of omnidirectional signalling for bipartite/small network communications. The omnidirectional transmit signal power required to ensure that the intended recipient device receives a sufficiently strong signal to decode a message accurately is very much greater than the threshold receive signal power (receiver sensitivity). Unless a communication device is simultaneously communicating with a very large number of devices spread out in a large number of directions, much of that transmit signal power is wasted.

Additionally, many wireless communication systems suffer from interference from nearby communication devices with which they are not intended to communicate. This can result in low throughput as transmissions from interfering devices can clash with signals internal to the communication systems, necessitating retransmissions. It may also be necessary to increase transmit power even further in order to drown out interferers.

One technique which can help to address both these problems is beamforming. A beamforming transmitter device controls the phase and relative amplitude of the signals it transmits in order to create a pattern of constructive and destructive interference in the wave fronts of the signals. This can concentrate the signals within a desired angular range or ranges, reduce the transmitted power into a given angular range or ranges, or both. Similarly, a beamforming receiver device interprets the pattern of signal power it receives such that relatively more attention is given to signals originating from within a desired angular range or ranges, relatively less attention is given to signals originating from a given angular range or ranges, or both. Beamforming transceiver devices implement beamforming for both transmission and reception. Arrays of antennas or speakers/microphones facing in different directions and/or spaced apart may be used, exploiting the manner in which electromagnetic or sound waves respectively combine constructively or destructively at particular locations. These technologies mean that transmissions can be aimed at the target device, receivers can be oriented towards transmitters and nulls can be directed towards interferers. This all leads to improved throughput and power efficiency.

“Interferers” in the context of this application may be other communication devices from the same network/system with which communication is not currently desired, or signal sources from outside of the network/system. A “null” may be a signal designed, using analysis and/or prediction of an interfering signal, to at least partially cancel out that interfering signal, reducing its impact on desired communications. Alternatively, aiming a “null” at an interferer could indicate that the power transmitted into, or the relative attention given to signals received from, an angular range surrounding the interferer is reduced. “Orientation”, “aiming”, “directionality” and similar words/phrases, in the context of this application, may be related to physical orientation of transmitters/receivers, or may refer to signal processing techniques which simulate the effects of different physical orientations/configurations of transmitters/receivers on transmitted or received signals, for example by adjusting the various weights given to signal components communicated via each of an array of transmitters/receivers.

In dynamic environments where communication devices or interferers are mobile and/or have periods of activity and inactivity the directionality of beamforming devices must adapt to the changing bearing of their target; whether that target is a friendly device with which communication is desired, or an interferer towards which a null may be directed.

In the case of beamforming to reduce the impact of interferers, the direction of an interferer may be found by determining the orientation of a beamforming device's receiver in which the interfering signal is strongest. A signal null may then be aimed in that direction for subsequent transmission/reception. This procedure may be performed periodically or in response to detection of unacceptable levels of interference.

Adaptive beamforming to facilitate more efficient communication with friendly devices on the other hand involves from time to time transmitting a dedicated adaptive beamforming communication to determine accurately and precisely the direction in which a target device lies.

Beamforming signalling between devices may be implicit or explicit. That is, a beamforming device may receive a training sequence signal from a target and may infer the direction of the target from the orientation of its receiver in which the signal is strongest, and then adjust its subsequent transmission/reception accordingly. Alternatively, the beamforming device may send a training sequence signal to the target. The target may then determine the direction of the beamforming device and transmit this information explicitly to the beamforming device which can adjust its subsequent transmission/reception accordingly.

However the overhead requirements of such adaptive beamforming communications can be prohibitively large, resulting in unacceptably low throughput. The frequency with which adaptive beamforming communications are sent must be carefully chosen for each application so that the beamforming is accurate enough that the efficiency gains outweigh the high airtime requirements.

There is increasing requirement for accurate and efficient adaptive beamforming for use in applications such as mobile networks where both locations of devices and the interference landscape can change rapidly, users have high throughput requirements, and power efficiency is a key consideration so as to, for example, prolong the battery life of communication devices.

What is needed is a way of improving the accuracy and/or efficiency of adaptive beamforming techniques.

According to a first aspect of the invention, there is provided a first communication device comprising a signal receiver for receiving signals from a plurality of directions, the first communication device being configured to: at a time t determine the direction in which a second communication device lies with respect to the first communication device through an adaptive beamforming communication with the second communication device; and (i) if the communication device comprises a signal transmitter for transmitting signals in a plurality of directions, subsequently arrange the transmitter to favour transmitting signals in a first direction with respect to the first communication device; and/or (ii) subsequently arrange the signal receiver to favour receiving signals in a second direction with respect to the first communication device, wherein the first and second directions are chosen from the said plurality of directions according to the determination of the direction in which the second communication device lies with respect to the first communication device at time t; the first communication device being further configured to: determine time t in dependence on position data from one or both of the first and second communication devices that indicates, or may be used to estimate, their relative positions and/or any change therein.

The first communication device may be configured to from time to time re-determine the direction in which the second communication device lies with respect to the first communication device through further adaptive beamforming communications with the second communication device.

The first communication device may be configured to periodically re-determine the direction in which the second communication device lies with respect to the first communication device through said further adaptive beamforming communications with the second communication device. The first communication device may be configured to determine what the period between adaptive beamforming communications should be in dependence on the position data.

The first communication device may be configured to: if the first communication device is arranged to exchange data traffic with the second communication device, choose the first and/or second directions to be substantially the same as the direction in which the second communication device is determined to lie at time t; and/or if the second communication device is determined to be interfering with communications between the first communication device and a third communication device, choose the first and/or second directions to be substantially opposite to the direction in which the second communication device is determined to lie at time t.

The first communication device may be configured to detect the position data.

The first communication device may be configured to receive position data detected and transmitted by the second communication device or a fourth communication device.

The position data may be received from an accelerometer. The position data may be received from a satellite navigation or land-based triangulation system.

The position data may be received from apparatus which forms the position data by triangulating the position of one of the first and second communication devices from relative positions of the other of the first and second communication devices and a fourth communication device, said relative positions of the other of the first and second communication devices and a fourth communication device being known prior to the triangulation. The fourth communication device may be an access point.

The first communication device as claimed in any preceding claim, configured to use position data received from detection of Doppler shift in the frequencies of signals received by the device(s) which determines the position data.

The first communication device may be configured to determine time t in dependence on position data indicating that one of the first and second communication devices has moved by more than a predetermined threshold distance in a predetermined time.

The first communication device may be configured to determine time t in response to receiving position data indicating that one of the first and second communication devices has moved by more than a predetermined threshold distance in a predetermined time.

The first communication device may be configured to determine time t in response to making a determination that the quality of a link on which the first communication device is communicating: (a) is dropping, and/or (b) has dropped below a predetermined threshold. The determination of the quality of the link may be made according to a measurement of bit error rate and/or packet error rate and/or received signal strength indication.

The first communication device may be configured to determine time t in response to making a determination that the quality of a link on which the first communication device is communicating: (c) is anticipated to change in the near future. The first communication device may be configured to make a determination that the quality of the link is anticipated to change in the near future according to an indication that a communication device has joined or left the communications network.

The first communication device may be configured to determine time t by: determining from the position data that an adaptive beamforming communication is needed; subsequently determining when the next available timeslot for an adaptive beamforming communication is according to the communication protocol used by the first communication device; and defining said timeslot as time t.

The first communication device may be configured to determine what the period between adaptive beamforming communications should be in response to receiving position data indicating that one of the first and second communication devices has moved by more than a predetermined threshold distance in a predetermined time.

The first communication device may be configured to use the position data to determine the speed of relative motion between the first and second communication devices, and to increase the period between adaptive beamforming signals when said speed is determined to have decreased.

The first communication device may be configured to use the position data to determine the speed of relative motion between the first and second communication devices, and to decrease the period between adaptive beamforming signals when said speed is determined to have increased. The first communication device may be configured to set the period between adaptive beamforming communications to a value in predetermined proportion to said speed.

The first communication device may be configured to create the position data by using previously received position data to predict the trajectory of the second communication device relative to the first communication device.

According to a second aspect of the invention, there is provided a method for adaptive beamforming comprising the steps of: at a time t, determining the direction in which a second communication device lies with respect to a first communication device through an adaptive beamforming communication between the first and second communication devices; subsequently (i) arranging a signal transmitter unit of the first communication device to favour transmitting signals in a first direction chosen from a plurality of directions in which said signal transmitter unit can transmit, and/or (ii) arranging a signal receiver unit of the first communication device to favour receiving signals in a second direction chosen from a plurality of directions in which said signal receiver unit can receive, according to the determination of the direction in which the second communication device lies with respect to the first communication device at time t; wherein the time t is determined in dependence on position data from one or both of the first and second communication devices that indicates, or may be used to estimate, their relative positions and/or any change therein.

Aspects of the present invention will now be described by way of example with reference to the accompanying figures. In the figures:

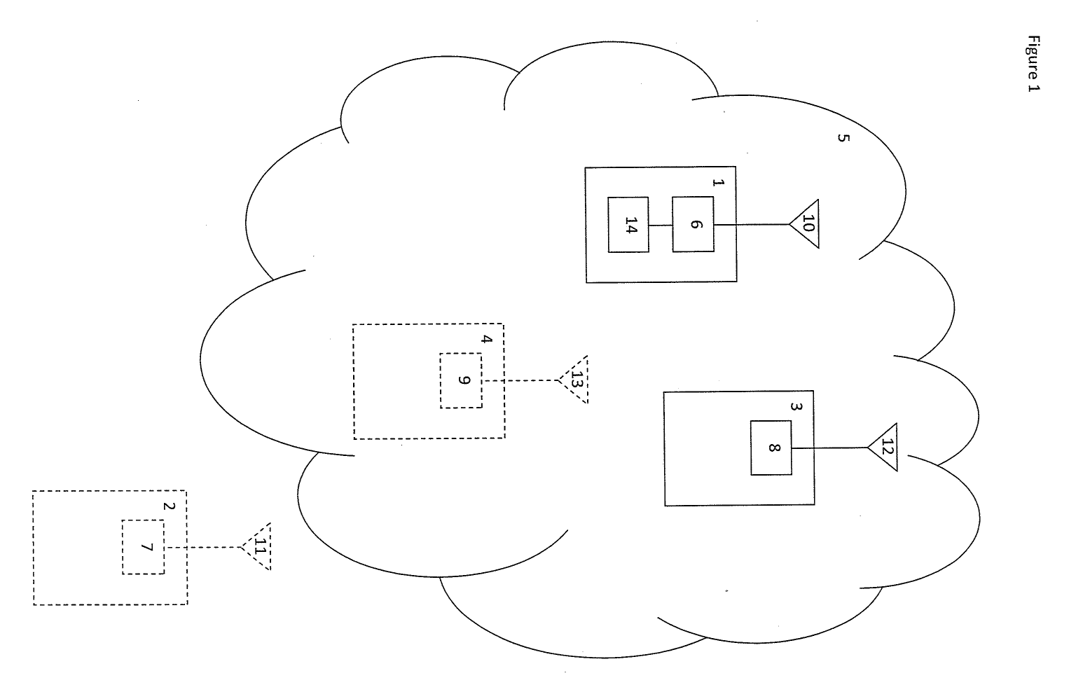

FIG. 1 shows an example communication environment; and

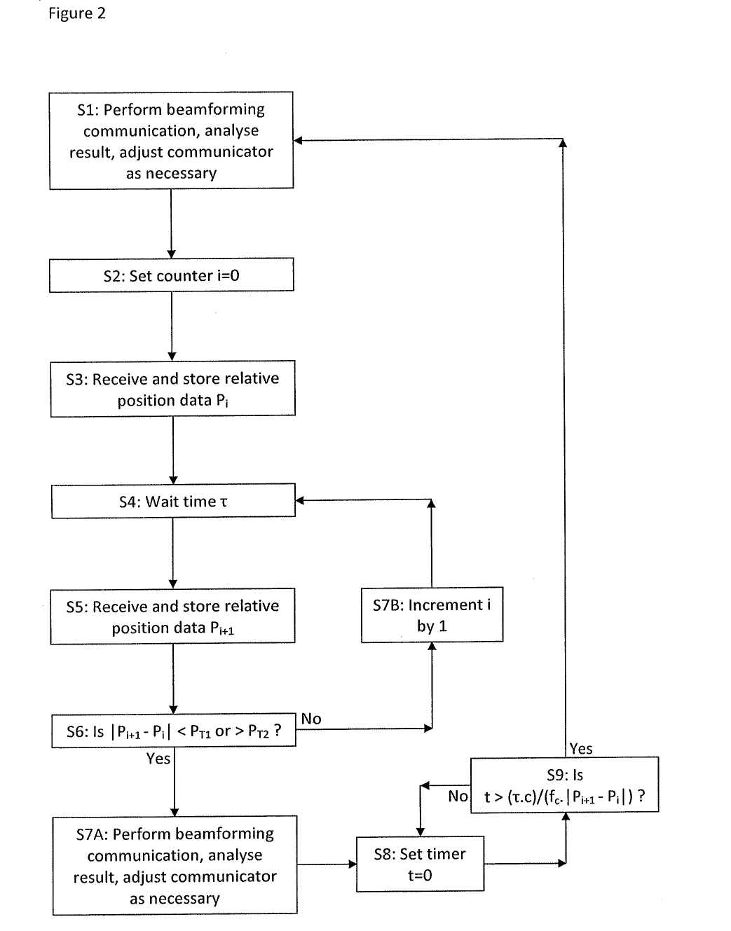

FIG. 2 is a flow chart for an example method.

The following description is presented to enable any person skilled in the art to make and use the system, and is provided in the context of a particular application. Various modifications to the disclosed embodiments will be readily apparent to those skilled in the art.

The general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

A first communication device implements adaptive beamforming with respect to a second communication device. That is, the first communication device controls the degree and/or direction of the anisotropy of a receiver and/or transmitter that it comprises according to the direction in which the second communication device is determined to lie, said determination being made using a communication between the first and second devices at a particular time. A suitable time for that adaptive beamforming communication to be made is chosen according to position data obtained from one or both of the communication devices.

Using position data to inform when adaptive beamforming communications should be sent allows for intelligent management of the delicate and often dynamic balance between transmitting enough adaptive beamforming communications to determine the appropriate directionality of the emitter/receiver accurately, and transmitting few enough adaptive beamforming communications that there is sufficient airtime available for the substantive communications.

FIG. 1 depicts a general scenario in which the method of the invention could be used. A beamforming communication device 1 communicates with a friendly communication device 3. Communication devices 1 and 3 are part of a communications network 5 which may contain other communication devices such as network communication device 4. There may also be unfriendly communication devices, not part of network 5, within range of one or more of the communication devices within network 5. Such communication devices may interfere with communications within network 5. An example of such an interferer is unfriendly communication device 2.

The beamforming may be implemented such that beamforming communication device 1 predominately transmits and/or receives substantially in the direction of friendly communication device 3. Alternatively or additionally, if there is an unfriendly communication device 2 present, the beamforming may be implemented such that beamforming communication device 1 predominately transmits and/or receives substantially in a direction opposite to that of unfriendly communication device 2; i.e. communication device 1 aims a null at unfriendly communication device 2. If a network communication device 4 is present but communication device 1 does not wish to communicate with it presently, then it may be treated in the same manner as unfriendly communication device 2, i.e. a null may be aimed at it.

Communication devices 1-4 are equipped with communication units 6-9 respectively. The communication unit 6 of the beamforming communication device 1 is either a receiver unit or a transceiver unit capable of both transmitting and receiving. The communication units 8 and 9 of the other communication devices within network 5 may each be a receiver unit, a transmitter unit, or a transceiver unit. Communication unit 7 of unfriendly communication device 2 may be a transmitter unit or a transceiver unit. If communication unit 6 of beamforming communication device 1 is a receiver unit, or a transceiver unit incapable of position data origination (position data will be described below), then communication unit 8 of friendly communication device 3 must be either a transmitter unit or a transceiver unit. If communication unit 6 of beamforming communication device 1 is a transceiver unit capable of position data origination, then communication unit 8 of friendly communication device 3 may be any of a receiver unit, a transmitter unit or a transceiver unit.

Signals are communicated between devices using communicators 10-13 connected to communication units 6-9 respectively. For the purposes of describing exemplary embodiments of the invention communication network 5 is a telecommunications network for wireless communication of electromagnetic signals, so communicators 10-13 are antennas. However communication network 5 could be for communication of other kinds of signals, for example it could be a sonar network for communication of sound signals, then communicators 10-13 would be speakers/microphones.

The communicator 10 of beamforming communication device 1 is capable of receiving or transmitting and receiving in a plurality of directions. Communicator 10 can be controlled by a controller 14 through communication unit 6 to transmit and/or receive predominately in a particular direction. That particular direction may be varied by controller 14. This allows beamforming communication device 1 to implement adaptive beamforming with respect to friendly communication device 3, unfriendly communication device 2, network communication device 4 or any combination of them.

One or both of beamforming communication device 1 and friendly communication device 3 comprise means to determine position data relating to the relative locations of friendly communication device 3 and/or unfriendly communication device 2 and/or network communication device 4 to beamforming communication device 1. This means may be, amongst other things, one or a combination of:
an accelerometer (such as a microelectromechanical system, or MEMS, accelerometer);
a satellite navigation device;
apparatus configured to detect a shift in the frequencies of signals received from the other communication devices whose positions are of interest that could be due to Doppler shift caused by movement of the other communication devices towards or away from the device receiving the signals;
a processor configured to integrate over time the modulus of any change in frequencies of signals received from the other communication devices whose positions are of interest that could be due to Doppler shift caused by movement of the other communication devices towards or away from the device receiving the signals;
apparatus configured to perform the ranging technique disclosed in international patent application publication WO 2004/074865, that is: a method for estimating the distance between a transmitter and a receiver, the transmitter being arranged to transmit a signal as a series of bursts, and the carrier frequency of each burst being set according to a predetermined sequence, the method comprising: forming a first series comprising the measured differences between the phases of successive bursts as received at the receiver; forming a second series comprising estimated differences between the phases of successive bursts as received at a supposed time difference between the transmitter and the receiver; and determining the quality of fit between the first series and the second series;
a processor configured to triangulate the positions of the communication devices whose positions are of interest with (an)other friendly communication device(s) with (a) known position(s), such as (a) stationary access point(s) or base station(s)—multiple other friendly communication devices will be required for this technique if it is not possible to validly approximate to two dimensions e.g. by assuming that devices are all located on land that is substantially flat on the scale of the horizontal distances between devices (if it is not one of the communication devices whose positions are of interest then network communication device 4 could be used for this technique, in which case communication unit 9 of network communication device 4 would have to be either a transmitter unit or transceiver unit); and
a gyroscope and/or gravity sensor configured to detect changes in the orientation of the communication device.

If beamforming communication device 1 comprises means for determining position data then the position data that means gathers is passed to controller 14. If friendly communication device 3 comprises means for determining position data, then friendly communication device 3 may gather position data and transmit it to beamforming communication device 1, then communication unit 6 may receive the position data from communicator 10 and pass it to controller 14.

Position data could be sent to the controller 14 at predetermined times, for example at regular intervals, or it could only be sent when it is determined that the relative positions of the communication devices of interest has changed by at least some predetermined threshold distance in some predetermined time. If position data is only sent in response to such a stimulus then the power and time overheads involved in sending the position data to the controller 14 may be reduced to the minimum necessary to keep the accuracy of the beamforming within acceptable limits. The greater the acceptable limits, the greater the predetermined threshold distance can be and the lower the power and time overheads from sending position data to the controller 14. However this technique does require the friendly communication device 3 to perform some analysis of the position measurements made before passing on the position data (which could be the raw measurements or some related indication e.g. a code that informs the beamforming communication device 1 of significant movement). This means that friendly communication device 3 must have adequate processing power for such operations; it may be less expensive, and therefore preferable, to restrict as much processing as possible to beamforming communication device 1. These considerations should be taken into account in the design of systems implementing the invention.

Position data could alternatively/additionally be sent to the controller in response to a determination that the link quality is dropping, and/or has dropped below a predetermined threshold, and/or is anticipated to change in the near future (e.g. if it is determined that a device has just joined or left the communications network). Link quality could for example be assessed according to measures such as bit error rate (BER), packet error rate (PER), or received signal strength indication (RSSI) or similar.

Controller 14 uses the position data it receives, whether directly from beamforming communication device 1 or from friendly communication device 3, or both, to determine the times at which adaptive beamforming communications should be made. They could be made at predetermined times, for example at regular intervals, or they could be made in response to an indication that the relative positions of the beamforming communication device 1 and target(s) 2 and/or 3 and/or 4 has changed by more than some predetermined threshold distance in some predetermined time.

If the sending of the position data is responsive then this may be used as the trigger to make an adaptive beamforming communication as soon as possible. This may be immediately or may have to wait until some other communication has finished. Precisely when the controller's request for an adaptive beamforming communication is accepted may be determined according to the communication protocol under which the beamforming communication device 1 operates.

If the adaptive beamforming communications are made periodically then the controller 14 receiving position data indicating relative motion between the beamforming communication device 1 and the target device(s) 2 and/or 3 and/or 4 may be the trigger for the period of the adaptive beamforming communication cycle to be reassessed.

Generally, it may be advantageous for the period between adaptive beamforming communications to be shorter the faster the relative motion between the beamforming communication device 1 and the target device(s) 2 and/or 3. Therefore, if the position data indicates that the speed of such relative motion has increased, the period between beamforming signals could be decreased. Similarly, if the position data suggests that the speed of the aforesaid relative motion has decreased, the period between beamforming signals could be increased. The relationship between the speed determined for the relative motion between beamforming communication device 1 and the target device(s) 2 and/or 3 and the period between beamforming signals applied following said determination may be inversely proportional.

More specifically, changes to the periodicity of the adaptive beamforming communication cycle may be made such that the frequency of adaptive beamforming communications is minimised subject to the accuracy of the beamforming remaining within acceptable limits. For example, if the position data indicates that the relative positions of the beamforming communication device 1 and target device 2 or 3 are changing at a speed of 2 m/s (as may be the case if, for example, one of the devices is a cellular base station and the other a cellular mobile telephone being carried by a user as they walk), and the frequency of the carrier signal onto which communications between the two devices are modulated is 5 GHz, then adaptive beamforming communications would be required with a frequency of at least 33 Hz in order to ensure the beamforming accuracy is kept to within one carrier signal wavelength. The criterion that the beamforming accuracy should be kept to within one carrier frequency wavelength may be expressed as:

f_{b}≧v/λ_{c}=v.f_{c}/c

where f_{b} is the frequency with which adaptive beamforming communications are made (i.e. the number of adaptive beamforming communications made per unit time), v is the relative speed of the beamforming device and target, λ_{c} is the wavelength of the carrier signal used for communications between the beamforming device and target, f_{c} is the frequency of that carrier signal and c is the speed of signal propagation (which will be the speed of light for electromagnetic systems). The frequency with which adaptive beamforming communications are made may be chosen to be on or close to the boundary value (the boundary value being v.f_{c}/c), possibly with some predetermined offset to ensure adaptive beamforming communications keep being made with some minimum acceptable frequency even if the position data feedback malfunctions or there is little or no relative movement between the beamforming communication device 1 and the target communication device 2 or 3. If it is determined that for a given system a greater or lesser degree of accuracy is required, then the boundary value could be multiplied by an appropriate value. For example, the boundary value could be multiplied by three if the system required one third wavelength accuracy, or by a half if two wavelength accuracy were to be sufficient.

It is generally preferable to obtain position data revealing changes in the relative positions of the communication device and target(s), however this may not be possible if both beamforming communication device 1 and target device 2 or 3 are mobile and only one has the capability to gather position data and pass that data to the controller 14. In some systems the additional cost and complexity of being able to determine relative positions may outweigh the additional accuracy gained. In those systems the change in position of one device relative to some arbitrary frame of reference of the means for gathering the position data must be assumed to lead to a corresponding change in the relative position of that device and the other device, even though this will not be the case if both devices are moving relative to the arbitrary reference frame.

It may be possible to gather enough information about the relative trajectories of the beamforming communication device 1 and the target device 2/3/4 from recent position data to predict position data for the immediate future. This could be used to make anticipatory changes to the timings of beamforming signals.

The flowchart shown in FIG. 2 outlines one of the selection of methods that may be used to implement the invention. After a beamforming adaptation procedure has been performed at step S1, some initial position data is gathered and the relative position of the beamforming communication device and the target communication device (Pᵢ, with i initialised to 0 at step S2) is determined at step S3. After waiting a predetermined time t at step S4, another determination of relative position (Pᵢ₊₁) is made at step S5. If the distance between Pᵢ and Pᵢ₊₁ is not greater than a lower threshold distance P_{T1}, or less than an upper threshold distance P_{T2}, then through steps S6 and S7B the previous step is repeated until the distance between Pᵢ and Pᵢ₊₁ is no longer within the allowed range of P_{T1} to P_{T2}. Then at step 7A another beamforming adaptation procedure is performed and a timer is set to expire after a beamforming period corresponding to the boundary case for one wavelength beamforming accuracy discussed above at steps S8-S9. When the timer expires the method returns to step S1.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A first communication device comprising a signal receiver for receiving signals from a plurality of directions, the first communication device being configured to:
at a time t determine the direction in which a second communication device lies with respect to the first communication device through an adaptive beamforming communication with the second communication device; and
(i) if the communication device comprises a signal transmitter for transmitting signals in a plurality of directions, subsequently arrange the transmitter to favour transmitting signals in a first direction with respect to the first communication device; and/or
(ii) subsequently arrange the signal receiver to favour receiving signals in a second direction with respect to the first communication device,
wherein the first and second directions are chosen from the said plurality of directions according to the determination of the direction in which the second communication device lies with respect to the first communication device at time t;
the first communication device being further configured to:
determine time t in dependence on position data from one or both of the first and second communication devices that indicates, or may be used to estimate, their relative positions and/or any change therein.

2. A first communication device as claimed in claim 1, configured to from time to time re-determine the direction in which the second communication device lies with respect to the first communication device through further adaptive beamforming communications with the second communication device.

3. A first communication device as claimed in claim 2, configured to periodically re-determine the direction in which the second communication device lies with respect to the first communication device through said further adaptive beamforming communications with the second communication device.

4. A first communication device as claimed in claim 3, configured to determine what the period between adaptive beamforming communications should be in dependence on the position data.

5. A first communication device as claimed in claim 1, configured to:
if the first communication device is arranged to exchange data traffic with the second communication device,
choose the first and/or second directions to be substantially the same as the direction in which the second communication device is determined to lie at time t; and/or
if the second communication device is determined to be interfering with communications between the first communication device and a third communication device,
choose the first and/or second directions to be substantially opposite to the direction in which the second communication device is determined to lie at time t.

6. A first communication device as claimed in claim 1, configured to detect the position data.

7. A first communication device as claimed in claim 1, configured to receive position data detected and transmitted by the second communication device or a fourth communication device.

8. A first communication device as claimed in claim 1, wherein the position data is received from an accelerometer.

9. A first communication device as claimed in claim 1, wherein the position data is received from a satellite navigation or land-based triangulation system.

10. A first communication device as claimed in claim 1, wherein the position data is received from apparatus which forms the position data by triangulating the position of one of the first and second communication devices from relative positions of the other of the first and second communication devices and a fourth communication device, said relative positions of the other of the first and second communication devices and a fourth communication device being known prior to the triangulation.

11. A first communication device as claimed in claim 10, wherein the fourth communication device is an access point.

12. A first communication device as claimed in claim 1, configured to use position data received from detection of Doppler shift in the frequencies of signals received by the device(s) which determines the position data.

13. A first communication device as claimed in claim 1, configured to determine time t in dependence on position data indicating that one of the first and second communication devices has moved by more than a predetermined threshold distance in a predetermined time.

14. A first communication device as claimed in claim 1, configured to determine time t in response to receiving position data indicating that one of the first and second communication devices has moved by more than a predetermined threshold distance in a predetermined time.

15. A first communication device as claimed in claim 1, configured to determine time t in response to making a determination that the quality of a link on which the first communication device is communicating:
(a) is dropping, and/or
(b) has dropped below a predetermined threshold.

16. A first communication device as claimed in claim 15, wherein the determination of the quality of the link is made according to a measurement of bit error rate and/or packet error rate and/or received signal strength indication.

17. A first communication device as claimed in claim 1, configured to determine time t in response to making a determination that the quality of a link on which the first communication device is communicating:
(c) is anticipated to change in the near future.

18. A first communication device as claimed in claim 17, configured to make a determination that the quality of the link is anticipated to change in the near future according to an indication that a communication device has joined or left the communications network.

19. A first communication device as claimed in claim 1, configured to determine time t by:
determining from the position data that an adaptive beamforming communication is needed;
subsequently determining when the next available timeslot for an adaptive beamforming communication is according to the communication protocol used by the first communication device; and
defining said timeslot as time t.

20. A first communication device as claimed in claim 3, configured to determine what the period between adaptive beamforming communications should be in response to receiving position data indicating that one of the first and second communication devices has moved by more than a predetermined threshold distance in a predetermined time.

21. A first communication device as claimed in claim 3, configured to use the position data to determine the speed of relative motion between the first and second communication devices, and to increase the period between adaptive beamforming signals when said speed is determined to have decreased.

22. A first communication device as claimed in claim 4, configured to use the position data to determine the speed of relative motion between the first and second communication devices, and to decrease the period between adaptive beamforming signals when said speed is determined to have increased.

23. A first communication device as claimed in claim 22, configured to set the period between adaptive beamforming communications to a value in predetermined proportion to said speed.

24. A first communication device as claimed in claim 1, configured to create the position data by using previously received position data to predict the trajectory of the second communication device relative to the first communication device.

25. A method for adaptive beamforming comprising the steps of:
at a time t, determining the direction in which a second communication device lies with respect to a first communication device through an adaptive beamforming communication between the first and second communication devices;
subsequently
(i) arranging a signal transmitter unit of the first communication device to favour transmitting signals in a first direction chosen from a plurality of directions in which said signal transmitter unit can transmit, and/or
(ii) arranging a signal receiver unit of the first communication device to favour receiving signals in a second direction chosen from a plurality of directions in which said signal receiver unit can receive,
according to the determination of the direction in which the second communication device lies with respect to the first communication device at time t; wherein
the time t is determined in dependence on position data from one or both of the first and second communication devices that indicates, or may be used to estimate, their relative positions and/or any change therein.

26. (canceled)

27. (canceled)
